(19) United States
(12) Patent Application Publication
(10) Pub. No.: US 2020/0017240 A1
(43) Pub. Date: Jan. 16, 2020

(54) GLOBAL WARMING OR COOLING MITIGATION AND SOLAR ENERGY SYSTEM

(71) Applicant: ROBERT S. CARNEY, MINNEAPOLIS, MN (US)

(72) Inventor: ROBERT S. CARNEY, MINNEAPOLIS, MN (US)

(21) Appl. No.: 16/512,727

(22) Filed: Jul. 16, 2019

Related U.S. Application Data
(60) Provisional application No. 62/698,604, filed on Jul. 16, 2018.

(51) Int. Cl. B64G 1/10; B64G 1/24; B64G 1/64; B64G 1/44; B64G 1/40; B64G 1/66

(52) U.S. Cl. CPC B64G 1/10; B64G 1/242; B64G 1/648; B64G 2001/1092; B64G 1/405; B64G 1/66; B64G 1/44

(57) ABSTRACT

A global warming or cooling mitigation and solar energy system, comprising tethered pairs of reflecting mirror systems of similar or identical size, situated at approximately Lagrange Point One between the Earth and the Sun; a first, Sun facing mirror system reflects radiation to a second, Earth or near Earth facing mirror system, the second mirror system targets the radiation to solar panels, other targets for purposes such as weather management, or to a third mirror system in a geosynchronous orbit, which in turn can target solar panels on Earth during night time. Because only one of the two tethered mirror systems is sending radiation to Earth, the result is typically a 50% reduction of total energy reaching the Earth from, as measured by the surface area of the two mirrors; this causes global cooling. Because electrical energy can be generated from the invention, it is anticipated the invention can be practiced on a for profit basis, with global warming mitigation an automatic public benefit. The invention further comprises non-reflective, global cooling elements, which serve only to block radiation from the Sun. The tethered pairs of mirrors have ion engines for maneuvering and positioning, such that they can be positioned with minimal energy required on the approximate orbital path of Lagrange Point one, but far enough off to the side to intercept solar radiation that would have otherwise missed the Earth, thus they can be used to either increase or decrease global warming; in effect the invention can function as a giant Earth thermostat. Further applications, variations and anticipated benefits are detailed.

### BACKGROUND OF THE INVENTION

Global warming has been a major concern for decades. Although some dispute whether it is happening, if the scientific consensus is correct, the consequences for human life on Earth could be catastrophic. At the same time, powerful economic and political forces are aligned in favor of continuing our reliance on fossil fuel. Consequently, any proposed solution to global warming must meet multiple tests of validity, starting with these benchmark questions: is the solution scientifically and technological possible? Could it accommodate, if necessary, changes that might result in global cooling—another ice age? Is it economical or possibly even profitable to implement? Can a “business case” be made for it? Is it politically practical? Can it neutralize or win over people and interests that are currently aligned to resist solutions to global warming?

Relatively little attention has been paid to trying to control the total radiant energy reaching the Earth from the Sun. On the one hand, it's easy to understand why this approach might not be favored—there may be a kind of general, intuitive sense that it would be too mammoth and impractical to attempt. Instead, most discussion has been on ways to reduce humankind's reliance on fossil fuels as primary energy sources—moving instead towards a future of renewable energy sources 13 including solar and wind—and to electric vehicles in preference to internal combustion engines.

A plan to stop global warming by managing the total radiant energy reaching the Earth was presented in a 2006 article by Dr. Roger Angel, of the University of Arizona. His plan would put into orbit at Lagrange Point L1—a location about one million miles from the Earth and orbiting the Earth and the Sun once a year, such that the gravitational forces of the Earth and the Sun, and the orbital centripetal force, approximately offset, meaning that an object at L1 will continue to orbit the Sun, but will not fall towards either the Earth or the Sun—trillions of small, light refracting disk structures, that would intercept and refract radiation heading towards the Earth. Refracting rather than reflecting would reduce the need to mitigate radiation pressure, which would otherwise tend to displace the objects from the unstable Lagrange Point L1. Their location and orientation would be managed by control means. It was envisioned that such a system could be built and in place within about twenty-five years, blocking at 1.8% of the total solar flux area, at a cost of a few trillion U.S. dollars. Unfortunately, Dr. Angel's proposed approach fails to fully satisfy the list of questions posed above. More particularly, no means is proposed to manage the total solar flux reaching the Earth such that the entire system could be adjusted either up or down, like a global thermostat. While the system appears feasible for reducing global warming, it is not suited for addressing the possibility of global cooling. It would be an enormously expensive solution, and one that offers no economic or environmental benefits beyond the benefit of stopping global warming—a benefit that many see as overwhelmingly great importance, but that, as noted, many others see as addressing a problem that may not exist. Should global warming claims prove to be alarmist, the plan does not include other benefits that could justify it. In short, while this plan certainly qualifies for more study as a possible “emergency back-up” plan if our situation becomes desperate, it appears to be impractical at the present due to the cost, and the forces aligned to support the status quo. It doesn't adequately address the full list of questions presented above.

### BRIEF DESCRIPTION OF THE INVENTION

The invention broadly comprises a system providing multiple economic and environmental benefits, including but not limited to the capacity to stop and/or reverse global warming by reducing the total radiant energy reaching the Earth. Examples of benefits will be given throughout this specification, it being understood that a complete list of benefits is not offered; the relative priority assigned to each benefit, and the consequent proportion of resources devoted to realizing each benefit, can also be adjusted continuously as needed.

For purposes of the invention, L1 Prime is defined as a point nearer to the Sun than Lagrange Point L1, on the Earth/Sun common center of gravity axis. L1 Prime is determined as an engineering calculation to be a point at which, for the center of gravity of an object or a plurality of objects, possibly comprising tethers, the stronger net gravitational force from the Sun as compared to L1 offsets the radiation pressure from the Sun.

The invention further comprises a plurality of cooling system objects, which are typically deployed in tethered pairs near L1 Prime. Each cooling system object typically has a Sun-facing surface of very thin radiation-absorbing material. Each cooling system object's Sun-facing absorbing surface reaches equilibrium temperature such that the formerly Earth bound and highly directional radiation, which would otherwise have contributed to global warming, is dissipated as omnidirectional electromagnetic radiation. Positional and orientation modules further comprising programmable and/or remote control means, solar panels, fuel, and an omni-directable ion engine or other electric thruster used to reposition and/or redeploy the cooling system object, and to counteract any and all very small and varying net gravitational vectors that may arise, including from the Moon as it orbits the Earth.

The invention further comprises a plurality of base system objects having thin mirror surfaces that can direct solar radiation with a first level of precision sufficient to achieve, by means of three reflective surfaces, and over a total distance of up to about a million miles, concentrations of radiation that are approximately 90% or greater on a target area as compared to the original area irradiated by the Sun. The approximate criteria for a second, higher level of precision for base system objects at Lagrange Point L4 and/or Lagrange Point L5, situated at one point of an equilateral triangle that is on the orbital path of the Earth, such that the base of the triangle is between the Earth and the Sun, is to achieve, by means of two reflective surfaces, and over a total distances of about 93 million miles (about the distance from the Earth to the Sun) concentrations of radiation that are about 50% or greater on a target area as compared to the original area irradiated by the Sun. These base system objects are typically tethered in pairs, such that the location of the center of gravity of the tethered pair with respect to L1 Prime, and the force vectors from gravity and radiation pressure acting on the pair of objects approximately cancel. Base system objects typically further comprise two positional management structures, these structures further comprise solar powered ion engines or other means to offset the net effect of all other gravitational force vectors not on the line between the center of gravity of the Earth and the Sun—the moon will generate one such force vector; displacement from the exact location of Lagrange Point One will generate another such force vector. Ion engines, possibly in combination with other engines capable of greater short-term bursts of power, will also be used to continually manage the targeting of reflected radiation from base system objects. The radiant energy reaching each base system object is so many orders of magnitude greater than the ion engine's fuel and energy requirements, and the degradation process acting on the solar power means due to cosmic rays happens so slowly, that the frequency of required refueling and maintenance for base system objects will be measured in years or decades.

When a tethered pair of base system objects is between the Earth and the Sun and is operating in full global cooling mode, both will direct radiation from the Sun away from the Earth, thus reducing the total solar flux reaching the Earth, cooling the Earth, and remediating global warming. When the tethered pair is operating in partial global cooling mode, the first base system object, nearest the Sun, will direct radiation from the Sun away from the Earth, while the second base system object, nearest the Earth, will direct radiation from the Sun towards the facing side of the first base system object, which, in turn will direct the radiation either towards the Earth, or towards a third base system object, typically in a geosynchronous or near-geosynchronous Earth orbit, which, in turn, will direct the radiation towards the Earth. In either case, when the pair is operating in partial global cooling mode, the radiation that originally reached the second base system object can be used for various purposes, including but not limited to these examples: powering solar cells on the Earth's surface, supplying power to solar cells mounted on permanent platforms above the Earth, supported by lighter-than-air means; and mitigating and/or disrupting and destroying hurricanes. The economic and environmental advantages deriving from these uses of radiation directed towards the Earth from the base system object are more than sufficient to justify implementing the present invention based purely on ethical, economic and environmental benefits that are other than any effect on global warming per se.

Base system objects deployed near L1 Prime, either tethered or untethered, can also be situated far enough away from L1 Prime such that they do not intercept solar radiation that would otherwise have reached the Earth; when so situated, they can function cooperatively such that the first base system object reflects radiation from the second base system object towards the Earth rather than away from the Earth, thus increasing the total solar flux reaching the Earth. Such a cooperating pair of base system objects is said to be functioning in partial global warming mode; such a deployment of base system objects can increase rather than decrease global warming, when and if this should ever be necessary or desirable. Once in position near L1 Prime, only a small amount of energy is necessary to alter the deployment of tethered base system objects back and forth between a first position such that they intercept radiation from the Sun that would otherwise have reached the Earth to a second position such that both intercept radiation from the Sun that would otherwise not have reached the Earth. This flexibility of deployment—alternating as needed between partial global warming mode and partial global cooling mode, enables a significantly or fully implemented total system of the present invention to function as a kind of global thermostat, cooling and/or warming the planet as desired.

Aside from the capability to stop and/or reverse global warming, other benefits and/or potential benefits include, but are not limited to: providing energy output at greatly reduced net cost to solar panels located anywhere on Earth; the panels can operate up to 24 hours a day whenever clouds are absent; powering electromagnetic mass drivers that can launch payloads into orbit many times a day, with minimal or no need for supplemental chemical rocket engines, by means of solar panels on giant platforms supported permanently in the upper atmosphere, above the level of clouds, depending for vertical support on lighter-than-air technology and structures, said solar panels in turn powering and thus greatly reducing the cost per unit of mass to place objects in Low Earth Orbit (“LEO”); continuous generation and transmission of high voltage AC electricity by means of solar panels on giant Earth-tethered platforms supported permanently in the upper atmosphere, above the level of clouds, depending for vertical support on lighter-than-air technology and structures, and transmitting generated electricity to ground level by power cable systems which, in turn, may further comprise lighter-than-air technology and structures for vertical support; maintaining and operating flying airports, comprising solar panels on giant platforms supported permanently in the upper atmosphere, above the level of clouds, depending for vertical support on lighter-than-air technology and structures, said platforms providing landing and take-off means for large solar powered and/or hydrogen powered aircraft further comprising lighter-than-air technology, either tethered to a geographic location, or circulating in the upper atmosphere according to prevailing winds, and further comprising means for other aircraft powered by conventional jet engines and/or rockets to move people and/or materials to and from conventional airports on the ground, some Earth-tethered embodiments further comprising elevator-like structures for moving people and/or material rapidly to and from the Earth's surface; mitigation or elimination of hurricanes and disruption of blizzards by means of temporarily concentrating solar radiation to disrupt the flow of air that causes them to form and grow; other weather management functions; desalination; and production of hydrogen fuel by water splitting. It should be noted that for all instances comprising solar panels in the upper atmosphere, the panels can potentially receive levels of radiation many times the intensity of that at the Earth's equator at noon on a cloudless day—to the extent that the panels can accept higher levels of radiation without being damaged by heat or other effects, this can increase the production of electricity for a given solar panel area.

If, contrary to the current scientific consensus, it turns out that global warming is not actually happening or is not as serious a problem as some people think, the priority assigned to other benefits can be increased, such that the present invention can be practiced with such enormous associated net economic value that it can and should be fully implemented as soon as possible. In short, to say this as simply as possible: as a business, political and economic plan, the present invention works perfectly, and should be implement as fully and quickly as possible, whether global warming is real or not. That debate is unnecessary. It is also possible to manage the operation of the present invention such that it is effective for stopping and/or reversing global cooling, should that ever emerge as a problem. In short, as noted, when fully implemented, the present invention can function as a de facto global thermostat.

### BRIEF DESCRIPTION OF DRAWINGS

Note that drawings illustrating the invention are not to scale.

FIG. 1 illustrates the Earth, the Sun, and Lagrange points L1 Prime, L4 and L5.

FIG. 2 illustrates L1 Prime and Space Zone One.

FIG. 2a illustrates L1 Prime, Space Zone One and Space Zone Three.

FIG. 3 illustrates L1 Prime and Space Zone Two.

FIG. 3a illustrates L1 Prime, Space Zone Two and Space Zone Four.

FIG. 4 illustrates a preferred embodiment of a cooling system object of the invention.

FIG. 4-1 illustrates a preferred embodiment of a tethered pair of cooling system objects of the invention.

FIG. 5 illustrates a preferred embodiment of a base system object of the invention.

FIG. 5-1 isolates and illustrates a preferred embodiment of an array component, an aluminum reflective surface module, of the invention.

FIG. 5-2 isolates and illustrates ties connecting at an intersection of a preferred embodiment of an array component, an aluminum reflective surface module, of the invention.

FIG. 5-3 isolates and illustrates connecting ties of a preferred embodiment of the invention.

FIG. 5a isolates and illustrates a pyramid-like rigid positional management structure above the reflective surfaces plane of a preferred embodiment of a base system object of the invention.

FIG. 5a1 isolates and illustrates only a pyramid-like rigid positional management structure of a preferred embodiment of a base system object of the present invention.

FIG. 5b illustrates a rigidity and positional management structure of a preferred embodiment of a base system object of the invention.

FIG. 5b1 isolates and illustrates a positional management module of a preferred embodiment of a base system object of the invention.

FIG. 5c isolates and illustrates positional management elements of a preferred embodiment of a base system object of the invention.

FIG. 5c1 isolates and illustrates positional management elements of a preferred embodiment of a base system object of the invention.

FIG. 6 illustrates a view of two tethered preferred embodiments of a base system object of the invention.

FIG. 6a illustrates the deployment with respect to the Earth and the Sun of three preferred embodiments of base system object of the invention.

FIG. 6a1 illustrates details of a tethered pair of base system objects of the invention.

FIG. 6a2 illustrates details of a third base system object of the invention.

FIG. 6b illustrates the deployment with respect to the Earth and the Sun of tethered preferred embodiments of a cooling system object and a third base system object of the invention.

FIG. 6b1 illustrates details of tethered preferred embodiments of a cooling system object and a third base system object of the invention.

FIG. 6c illustrates details of multiple Earth-orbiting positions of a preferred embodiment of a third base system object of the invention.

FIG. 6d illustrates the deployment of preferred embodiments of cooperating base system objects of the invention including at Lagrange Point L5.

FIG. 6d1 illustrates details of the deployment of a preferred embodiment of a base system object of the invention at Lagrange Point L5.

FIG. 6d2 illustrates details of the deployment of a preferred embodiment of a third base system object of the invention, in Earth orbit, and cooperating with another base system object at Lagrange Point L5.

### DETAILED DESCRIPTION OF THE PRESENT INVENTION

The invention is premised in part on four Space Zones, all defined with reference to Lagrange Point One, L1, in the Earth-Sun system—this is a point orbiting the Sun that remains on a line between the center of gravity of the Earth and of the Sun, and is approximately 1.5 million kilometers from the center of gravity of the Earth, or approximately 1 million miles, such that the gravitational force vectors of the Earth and the Sun result in a centripetal orbital vector such that an object orbits around the Sun once a year, while remaining at the same distance between the Earth and the Sun on a line between the centers of gravity of the Earth and the Sun. For purposes of the present invention, L1 Prime is defined as a point nearer to the Sun than Lagrange Point L1, on the Earth/Sun common center of gravity axis, and determined empirically to be a point at which the gravitational force vectors of the Earth and the Sun, together with radiation pressure on a tethered pair of standardized cooling system objects, or standardized base system objects, result in a centripetal orbital vector such that an object can orbit around the Sun once a year, while remaining at the same distance between the Earth and the Sun on a line between the centers of gravity of the Earth and the Sun. Note that L1 Prime may be at a different distance from the Sun for the center of gravity of standardized tethered pairs of cooling system objects and the center of gravity of standardized tethered pairs of base system objects. Objects located at Lagrange Point Four, L4 and Lagrange Point Five, L5, defined by the two equilateral triangles in the Sun/Earth orbital plane having one side from the center of gravity of the Earth to the center of gravity of the Sun, will also remain in orbit around the Sun, and will remain at the same distance from the Earth and from the Sun, these Lagrange points also have potentially useful attributes for the invention.

The perimeter of a circle on a plane that is perpendicular to the Earth/Sun common center of gravity axis, and centered on that common center of gravity axis, can represent a somewhat fuzzy but still useful Blocking Circle Boundary, such that for the area within the Blocking Circle Boundary, some or all radiation from the Sun will reach the surface of the Earth, while for the area outside the Blocking Circle Boundary, all radiation from the Sun will miss the Earth. Because the Sun's radius of 432,170 miles is greater than the Earth's radius of 3,959 miles, the radius of such a circle will vary linearly according to distance from the Earth of the center of the bounding circle. For both L1 and L1 Prime, that distance is approximately one million miles, accordingly, for the said Blocking Circle Boundary centered at approximately one million miles from the Sun, the radius of the circle is calculated to be approximately 8,600 miles. For purposes of the present invention, a Blocking Circle Boundary of radius 8,800 miles at L1 or L1 Prime will ensure that all radiation from the Sun passing outside the said Blocking Circle Boundary will miss the Earth unless it is redirected.

It should also be noted that the intensity of the radiation flux per unit of area on the surface of the said Blocking Circle Boundary that an object blocks from reaching the Earth will vary according to its distance from the center of the Blocking Circle Boundary; such that a spherical object at or near the center of the Blocking Circle Boundary will block more energy than the same spherical object situated near the perimeter of the Blocking Circle Boundary. For the present invention, an Optimal Cooling Zone Circle is defined as a circle on the plane of the Blocking Circle Boundary, having a common center with the Blocking Circle Boundary, and having a radius 2,000 miles; the said Optimal Cooling Zone circle area is approximately five percent of the said Blocking Circle Boundary area.

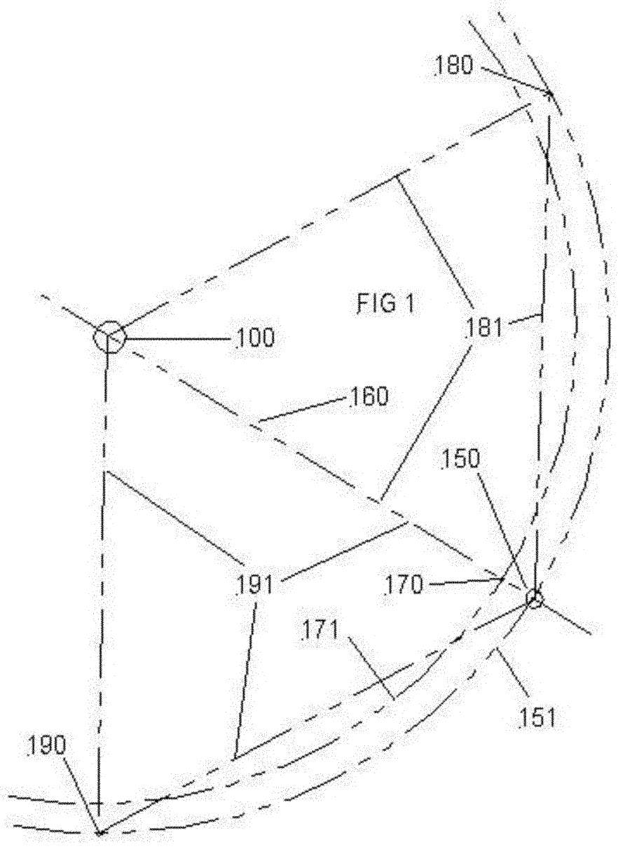

FIG. 1 illustrates the Sun, 100, the Earth, 150, L1 Prime, 170, L4, 180, and L5, 190, the orbital path around the Sun, 151, of the Earth, L4 and L5, the orbital path around the Sun of L1 Prime, 171, the Earth/Sun common center of gravity axis, 160, the equilateral triangle, 181, situating L4, and the equilateral triangle, 191, situating L5. Objects near L1 Prime can be maintained in their spatial position with respect to L1 Prime by applying on an as-needed basis relatively small forces that will vary in magnitude and direction and are always equal but opposite at every moment to the net force vector derived from the centripetal orbital vector of an orbiting object, together with the gravitational force vectors of the Earth, the Sun and the Moon, and the net radiation pressure vector. Such continuous forces can be generated by solar powered ion engines, or other means.

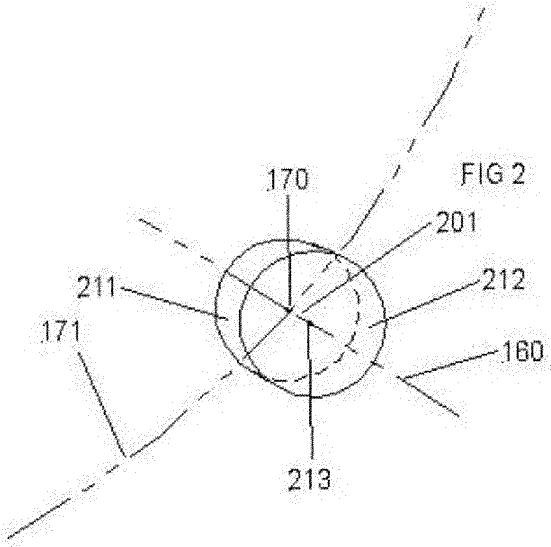

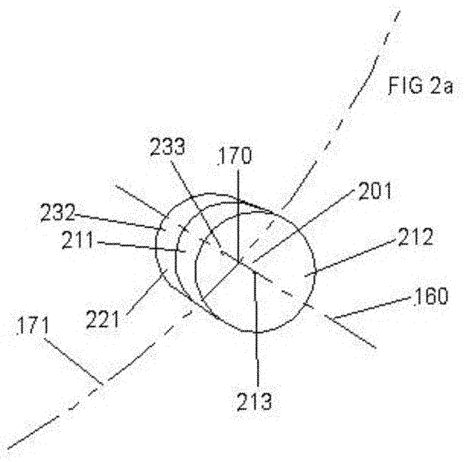

FIG. 2 illustrates L1 Prime, and Space Zone One, 201, comprising a right circular cylinder, having a first circular side, 211, with a radius of 2,000 miles, a radius associated with the Optimal Cooling Zone described above, that is centered on L1 Prime, 170, is on the L1 Prime orbital path, 171, and is on a plane perpendicular to the Earth/Sun common center of gravity axis, 160, and a second circular side, 212, having a center point, 213. The second circular side, 212, is of equal radius to and is parallel to the first circular side, 211, the second circular side center point, 213, is 50 miles closer to the Earth than is L1 Prime, 170.

FIG. 2a illustrates L1 Prime, Space Zone One, 201, as described above, and Space Zone Three, 221. Space Zone Three comprises a right circular cylinder that is a mirror image of the right circular cylinder of Space Zone One, 201. Space Zone Three, 221, comprises a first circular side, 211, that is also the first circular side of Space Zone One, that is centered on L1 Prime, 170, that is on the L1 Prime orbital path, 171, and that is on a plane perpendicular to the Earth/Sun common center of gravity axis, 160. Space Zone Three further comprises a second circular side, 232, having a center point, 233, the second circular side, 232, is of equal radius to and is parallel to the first circular side, 211, the second circular side center point, 233, is 50 miles closer to the Sun than is L1 Prime, 170.

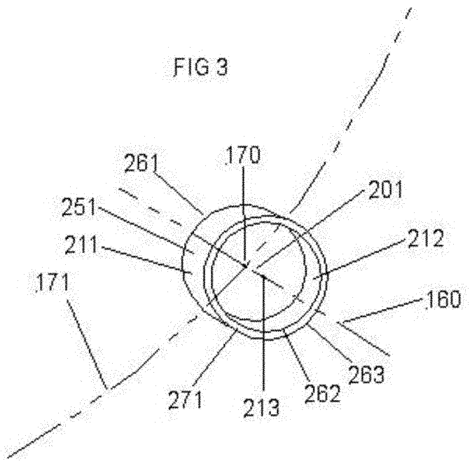

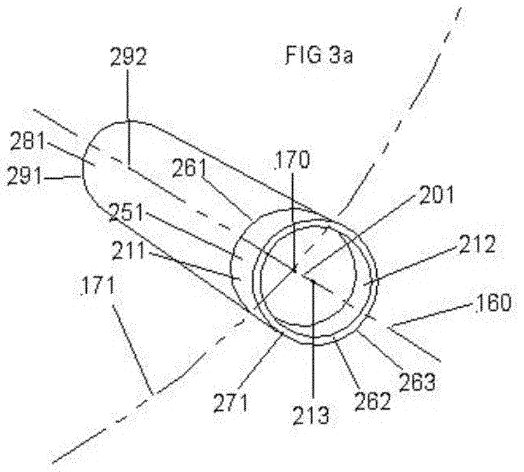

FIG. 3 illustrates L1 Prime, 170, and Space Zone Two, 251, a right circular hollow cylinder, bounded by a first annular base, 261, centered on L1 Prime, 170, on a plane that is perpendicular to the Earth/Sun common center of gravity axis, 160, and having a first inner circular boundary, 262, and a first outer circular boundary, 263 of radii approximately 8,800 and 9,000 miles respectively. The second annular base, 271, of Space Zone Two, 251, is centered on the second circular side center point, 213, of Space Zone One, 201, which is on the Earth/Sun common center of gravity axis, 160. The second circular side center point, 213, is on a plane parallel to the plane of the first annular base, 261, and is 50 miles closer to the Earth than is L1 Prime, 170. The second annular base, 271, has in common with the first annular base, 261, a first inner circular boundary, 262, and a first outer circular boundary, 263 of radii approximately 8,800 and 9,000 miles respectively.

FIG. 3a illustrates L1 Prime, Space Zone Two, 251, described above, and Space Zone Four, 281, a right circular hollow cylinder. Space Zone Four, 281, is an elongated mirror image of the right circular hollow cylinder Space Zone Two, 251. Space Zone Four, 281, is bounded by a first annular base, 261, that is also the first annular base, 261, of Space Zone Two, centered on L1 Prime, 170, on a plane that is perpendicular to the Earth/Sun common center of gravity axis, 160, and having a first inner circular boundary, 262, and a first outer circular boundary, 263 of radii approximately 8,800 and 9,000 miles respectively. The second annular base, 291, of Space Zone Four, 281, is parallel to the first annular base, 261, and is centered on a third center point, 292, which is on the Earth/Sun common center of gravity axis, 160, and is approximately 4,000 miles closer to the Sun than L1 Prime, 170. The second annular base, 291, has in common with the first annular base, 261, a first inner circular boundary, 262, and a first outer circular boundary, 263 of radii approximately 8,800 and 9,000 miles respectively.

The Space Zones One through Four have been defined such that when an object having a reflective or absorbing planar surface, or some combination, is oriented such that the plane of reflection is oriented in the general direction of the Sun and is within Space Zone One or Space Zone Three, its surface will reflect away and/or absorb radiation that would otherwise have reached the Earth. When an object having a reflective or absorbing planar surface, or some combination, is oriented such that the plane of reflection is oriented in the general direction of the Sun and is within Space Zone Two or Space Zone Four, its surface will reflect away and/or absorb radiation that would otherwise have not reached the Earth.

### First Preferred Embodiment of a Cooling System Object

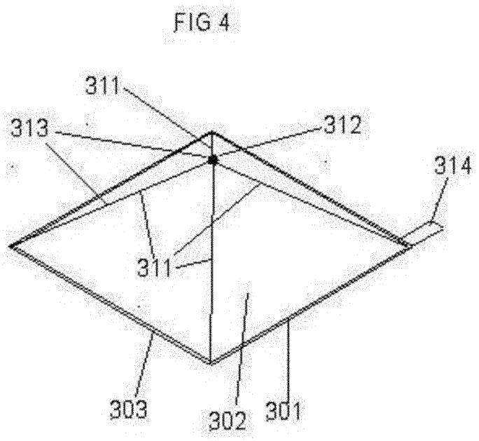

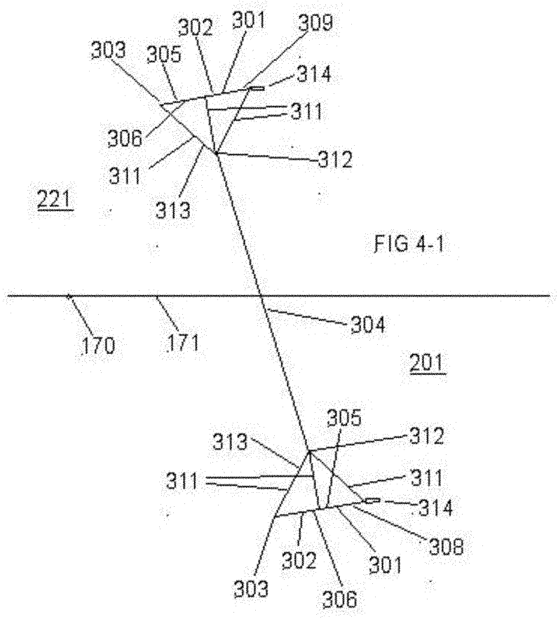

As illustrated by FIG. 4, a major element of the invention is a first preferred embodiment of a cooling system object, 301. Other embodiments of a cooling system object are anticipated. The invention broadly comprises a plurality of cooling system objects, 301, each one further comprising a continuous planar surface of radiation absorbing material, 302, within a continuous, planar, outer perimeter frame structure, 303, of the present invention. An attaching outer perimeter frame structure, 313, further comprises four struts, 311, each attaching to a corner of the continuous, planar, outer perimeter frame structure, 303, and each meeting at a central strut joint, 312. Each cooling system object, 301, further comprises a control and maneuvering module, 314, used to place and positionally maintain the cooling system object, 301, near L1 Prime, not illustrated in FIG. 4.

As illustrated by FIG. 4-1, cooling system objects, 301, are typically joined in pairs with a tether, 304, connecting on each side with a central strut joint, 312, with a first cooling system object, 308, in Space Zone One, 201, and a second cooling system object, 309, in Space Zone Three, 221. A continuous, planar, outer perimeter frame structure, 303, within the outer frame of each cooling system object, 301, will typically comprise a first, Sun-facing surface, 305, of absorbing material, having a composition and surface thickness to be optimized such that cost and weight are minimized—due to the likely cost of putting the material into orbit, weight is anticipated to be the driving parameter. The continuous, planar, outer perimeter frame structure, 303, may further comprise a second, Earth-facing surface, 306, having some proportion of absorbing and reflecting material, 306, having a composition such as to minimize cost and weight. The purpose of the Sun-facing surfaces, 305, of each cooling system object, 301, is to absorb solar radiation that would otherwise reach the Earth. Each cooling system object, 301, further comprises a cooling system outer perimeter frame structure, 313, further comprising a plurality of three or more struts, 311, each strut attaching to the continuous, planar, outer perimeter frame structure, 303, and meeting at a central strut joint, 312. Attaching to the continuous, planar, outer perimeter frame structure, 303, of each cooling system object, 301, is a control and maneuvering module, 314, further comprising computerized operating means that can be controlled remotely by radio or laser signals, a solar panel surface, a power module for using solar power to operate an ion engine which can be pointed in any direction, and mechanical means for crawling around the continuous, planar, outer perimeter frame structure, 303. The ion engine is positioned on the continuous, planar, outer perimeter frame structure, 303, as needed, and is used to change or maintain the position and orientation of the cooling system object, 301, with respect to L1 Prime, 170, either independently, or cooperatively as one of a pair of tethered cooling system objects, 301. The use of tethered pairs allows the center of gravity of the tethered pair to be situated on or very near the surface of a sphere centered on the center of gravity of the Sun, and having L1 Prime, 170, on the spherical surface, such that the gravitational vectors of the Earth and Sun are approximately equal and opposite at the center of a tethered pair of cooling system object, reducing and distributing the energy required from the ion engines, together with momentum transfers from other means, to maintain the position and orientation of the tethered cooling system object with respect to L1 Prime, 170. Because the magnitude of the net gravitational vector, and the magnitude of the net radiation pressure acting on the center of mass of a tethered pair of cooling system objects will be small relative to the power available from the ion engine, and the degradation process acting on the solar power means due to cosmic rays will proceed very slowly, the frequency of required maintenance and fueling service to control and maneuvering modules, 314, will be measured in years or decades. Should circumstances change such that we must mitigate global cooling rather than global warming, all the cooling system object can be moved by means of their ion engines to Space Zone Two and/or Space Zone Four, and maintained in those zones, such that no cooling system object, 301, will intercept or interfere with any solar radiation that would have otherwise reached the Earth.

### First Preferred Embodiment of a Base System Object

A base system object of the present invention comprises operation in a first reflector mode, or a second reflector mode. In first reflector mode, it is in Space Zone One or Space Zone Three and reflects radiation from the Sun towards another base system object. In second reflector mode, it is in Space Zone Two or Space Zone Four and reflects radiation from another base system object towards or near the Earth. As discussed later, a base system object can function in cooperation with other base system objects in a plurality of deployment modes.

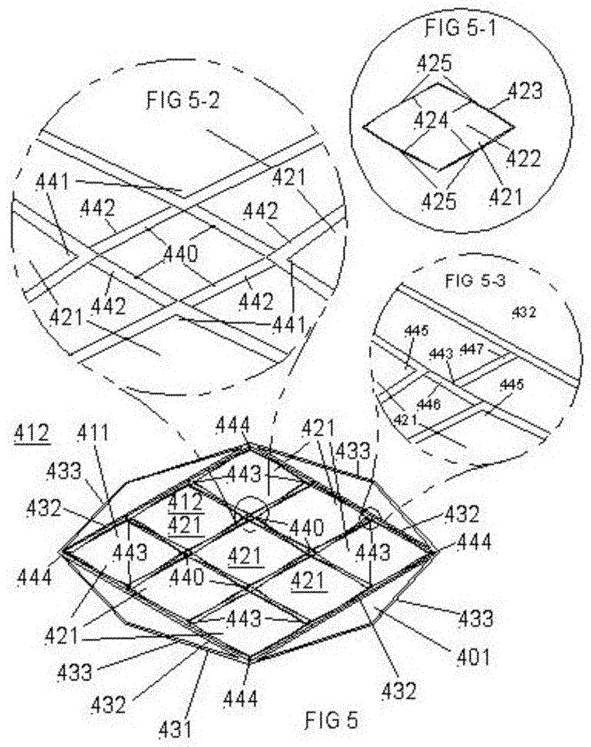

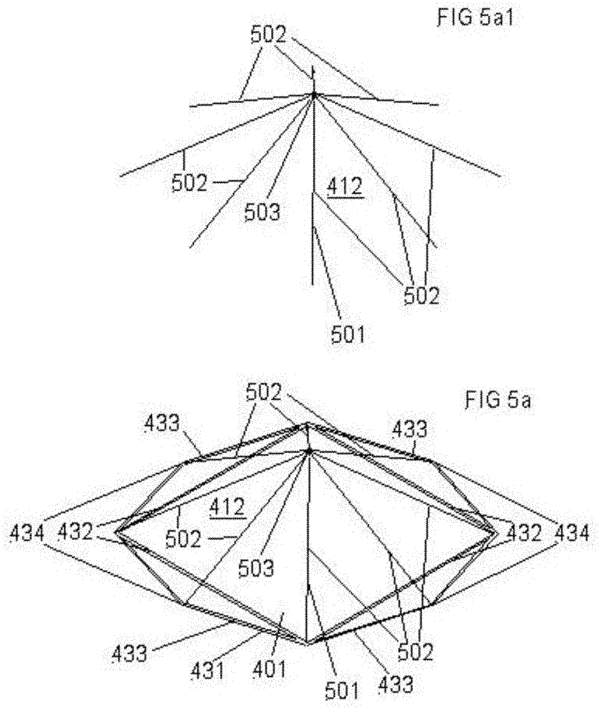

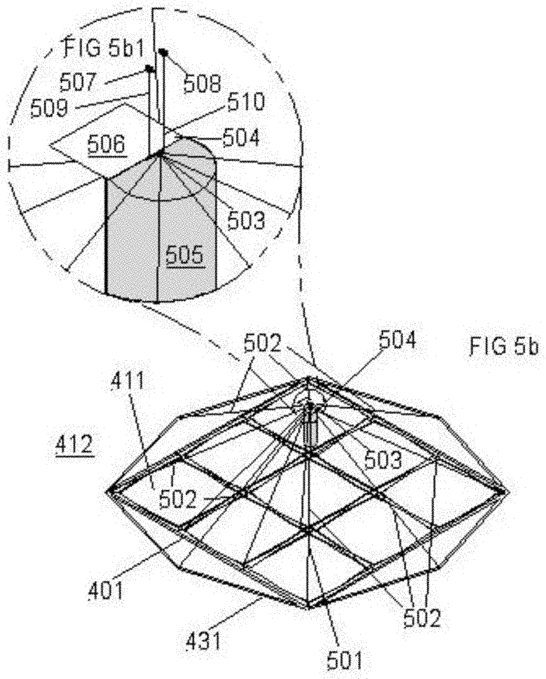

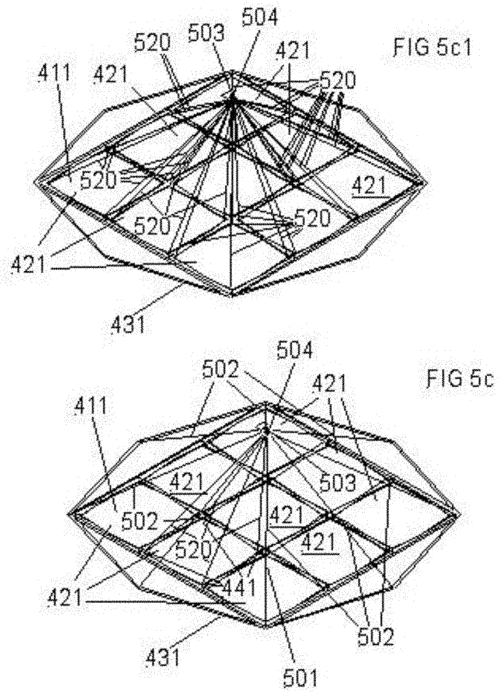

FIG. 5 illustrates elements of a preferred embodiment of a base system object, 401, comprising an N by N array, 411, of planar reflective surface modules, 421, of aluminum or other material, where N is an integer greater than 1; N may be 100, or a larger integer. Other embodiments of a base system object are anticipated. It should also be noted that while this preferred embodiment comprises an N by N array, the invention can be practiced with an N by M when N and M are unequal or equal integers greater than 1. FIG. 5-1 illustrates a preferred embodiment of a planar reflective surface module, 421, further comprising a planar, polished, reflective surface, 422, continuously attaching to a continuous, enclosing planar surface structure, 423, the said continuous, enclosing planar surface structure, 423, further comprising four bowed, rigid side struts, 424, each of which may be aluminum or some other light, rigid material—more generally the invention can be practiced with a plurality of three or more of the said bowed, rigid side struts. Continuing to refer now to the first preferred embodiment, each said bowed, rigid side strut, 424, is slightly bowed such that the distance from their centers, 425, to the center, 425, of an opposite bowed, rigid side strut, 424, is slightly greater than the length of a bowed, rigid side strut, 424. Within and adjoining the entire perimeter of each inner perimeter frame structure, 423, is a planar reflective surface module, 421, typically manufactured in space from rolls of aluminum material that are approximately five microns thick; these are commercially available. Such commercially available rolls have one surface that is shiny, and one that is flat—a result of the current industry standard manufacturing process. Neither surface of these commercially available rolls is typically of optical mirror quality; however, it is assumed that space-based manufacturing refinement techniques can and will be developed to render by compression, or surface buffing, or some other means, one or both surfaces as sufficiently smooth such as to be suitable for use as optical mirrors, and more particularly having a surface precision sufficient to achieve, as first quality standard, over a total distance of up to about a million miles, concentrations of reflected radiation that are approximately 90% or greater on a target area as compared to the original area irradiated by the Sun. An admittedly more aspirational goal is a second quality standard: to achieve over total distances of about one hundred million miles, about the distance of a path between Lagrange point L4 or L5, and then to the Earth, concentrations of radiation that are about 50% or greater on a target area as compared to the original area irradiated by the Sun. Alternatively, it will be understood that if and as needed, sufficiently smooth and flat reflecting mirror structures can be manufactured on Earth, and/or in space, and can be substituted for the said reflective aluminum surface structure, 422, rendering the first quality standard described above.

Referring now to FIG. 5, the N by N array, 411, of planar reflective surface modules, 421, is contained within a planer outer perimeter frame structure, 431, of aluminum struts or other rigid material, further comprising the continuous, joined bases, 432, of four outer isosceles triangles, 433—more generally the invention can be practiced with a plurality of three or more continuous, joined bases of outer isosceles triangles, defining a reflective surface plane. Continuing to refer now to the first preferred embodiment, these four outer isosceles triangles, 433, are on and define a reflective surface plane, 412, of a base system object, 401. The N by N array, 411, of planar reflective surface modules, 421, of a base system object, 401, of the present invention further comprises inner four corner intersections, 440. Referring now to FIG. 5-2, at these four-corner intersections, 440, the four corners, 441, for all four-corner intersections, 440, of planar reflective surface modules, 421, are all connected to adjacent planar reflective surface modules, 421, by extensible tie structures, 442. These extensible tie structures, 442, can be designed and deployed such that they always have at least a slight amount of tension on the two corners of adjacent planar reflective surface modules, 421, that they are connecting; they further comprise telescoping means, and/or they further comprise means for extending and retracting a light, thin, flexible cable-like structure; in either case, the length of extensible tie structures, 442, can be varied such as to accommodate a significant distance between the corners of two adjacent planar reflective surface modules, 421, along a line that is approximately perpendicular to their surfaces.

Referring now to FIG. 5, outer perimeter adjacent corner intersections, 443, of the N by N array, 411, of planar reflective surface modules, 421, are also connected by extensible tie structures, similar or identical to the extensible tie structures described elsewhere in this specification. Referring now to FIG. 5-3, the two adjacent outer perimeter corners, 445, at an outer perimeter adjacent corner intersection, 443, are illustrated, these corners are connected with a first outer perimeter extensible tie structure, 446, which in turn is connected by means of a second and perpendicular outer perimeter extensible tie structure, 447, to an adjacent outer isosceles triangle base, 432. The outer perimeter extensible tie structures, 446 and 447, are identical or very similar to the extensible tie structure, 442, as described and detailed above; they also serve to maintain a slight but continuous tension on the adjacent outer perimeter corners, 445, of the planar reflective surface modules, 421.

Referring now to FIG. 5, there is an outer perimeter outer corner extensible tie structure, 444, at each corner intersection of two outer isosceles triangle bases, 432, of the planar outer perimeter frame structure, 431, attaching an outer perimeter corner of a planar reflective surface modules, 421, to the corner intersection joint of two each of the outer isosceles triangle bases, 432. These outer perimeter outer corner extensible tie structures, 444, are also identical or very similar to the extensible tie structure, 442, as described and detailed above; they also serve to maintain a slight but continuous tension on the outer perimeter corners of their adjoining planar reflective surface modules, 421.

FIG. 5a isolates and illustrates an isometric view of elements of a pyramid-like rigid positional management frame, 501, above and adjoining the planar outer perimeter frame structure, 431, formed by the contiguous four outer isosceles triangles, 433, that define a reflective surface plane, 412, of a base system object, 401, of the present invention. The rigid positional management frame, 501, further comprises eight positional management frame struts, 502, each of these meets at a positional management structure central joint, 503, above the reflective surface plane, 412—more generally the invention can be practiced with a plurality of positional management frame struts, each of these struts attaching at one end to a positional management structure central joint, above one side of the said reflective surface plane, and each of these struts attaching at the other end to either a joint formed by two adjacent outer isosceles triangle bases, or to an outer isosceles triangle apex. Continuing to refer now to the first preferred embodiment, the other end of each positional management frame strut, 502, attaches to either the joint formed by two adjacent outer isosceles triangle bases, 432, or to an outer isosceles triangle apex, 434. For simplification and clarity, neither the N by N array of reflective aluminum surface modules of the present invention, nor their associated extensible tie structures, are illustrated in FIG. 5a.

FIG. 5a1 is similar to FIG. 5a, but, referring now to FIG. 5a1, further isolates and illustrates the pyramid-like rigid positional management frame, 501, by stripping away all elements except the eight positional management frame struts, 502, that meet at a positional management structure central joint, 503, above the reflective surface plane, 412, defined for this illustration by the ends of the eight positional management frame struts, 502, opposite to those ends that meet at the positional management structure central joint, 503.

FIG. 5b illustrates elements previously detailed with reference to FIG. 5a, referring again now to FIG. 5b: a pyramid-like rigid positional management frame, 501, above and adjoining an planar outer perimeter frame structure, 431, and further comprising eight positional management frame struts, 502, meeting a positional management structure central joint, 503, above the reflective surface plane, 412, associated with a base system object, 401, of the present invention. Adjoining the rigid positional management frame, 501, at the positional management structure central joint, 503, are elements comprising a positional management module, 504, further comprising, referring now to the enlarged view of FIG. 5b1, a positional management module fuel tank, SOS, a positional management module solar panel structure, 506, a positional management module first engine, 507, typically comprising an ion engine used to provide continuous directionally variable thrust with very little force, and a positional management module second engine, 508, typically used to provide brief bursts of higher and directionally variable thrust used to rapidly reorient the base system object, 401. The positional management module further comprise a first engine positioning and directional structure, 509, and a second engine positioning and directional structure, 510, having sufficient length, and a sufficient plurality of universal joints, such that they can be pointed in any direction except the profile of the positional management module fuel tank, SOS, the profile of the positional management module solar panel structure, 506, and, now referring to FIG. 513, the profile of the area bounded the planar outer perimeter frame structure, 431.

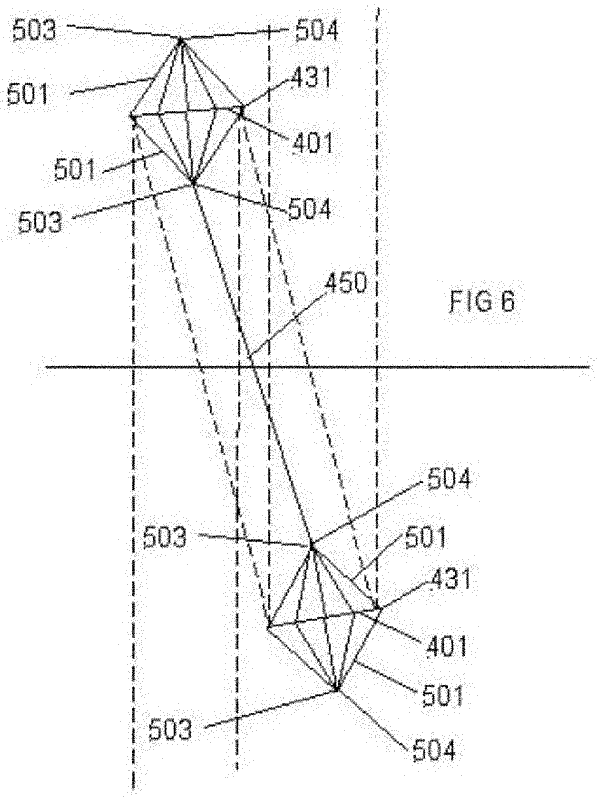

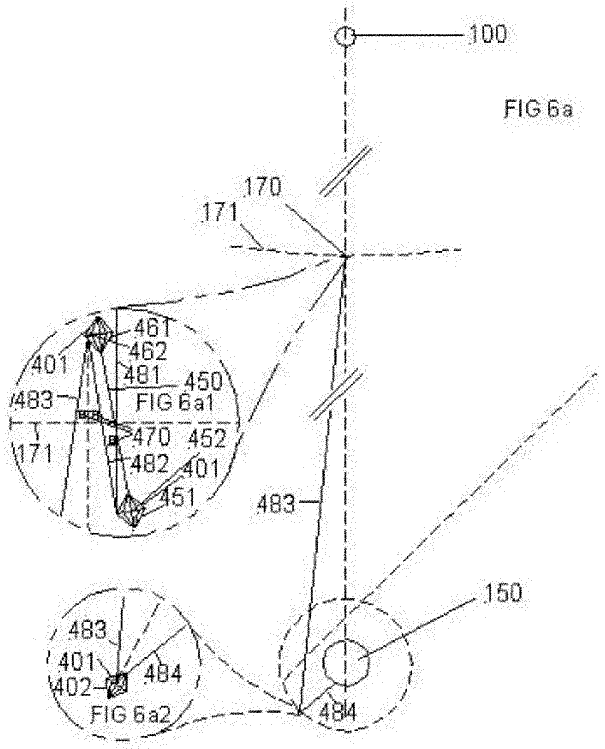

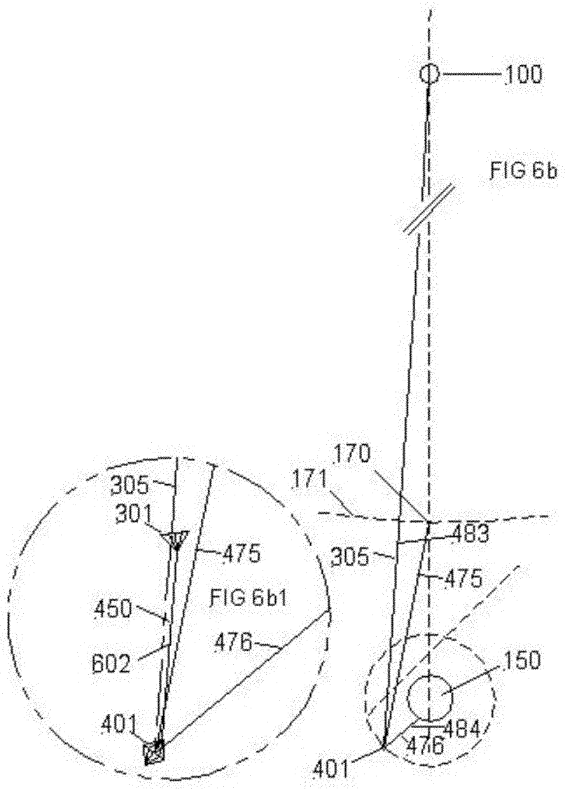

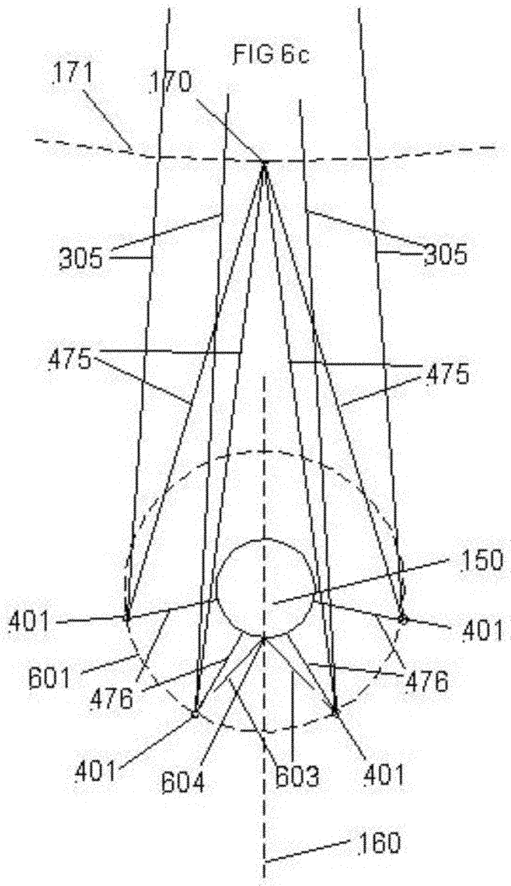

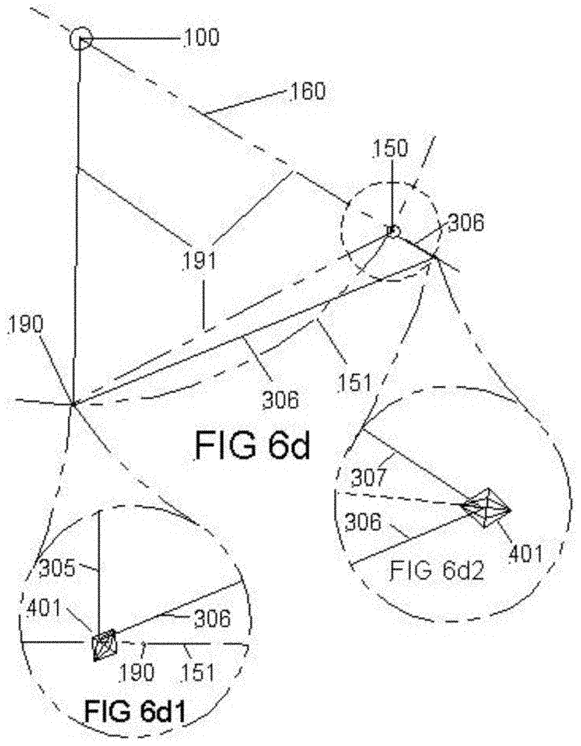

FIG. 6 illustrates a tethered pair of two base system objects, 401, joined by a tether, 450, each end of which is joined at a positional management structure central joint, 503, each having, as will be typical of base system objects, a rigid positional management frame, 501, on both sides of their planar outer perimeter frame structures, 431. When the present invention is practiced with tethered pairs of two base system objects, they are typically of identical or similar size. Each base system object, 401, further comprises, now referring to FIG. 5b1, all the elements, as described above, of the positional management module, 504. Any combination of the said engines of FIG. 5b1, referring again to FIG. 6, on opposite sides of a base system object, 401, can be operated cooperatively, or any engine can be used individually, such as to alter the spatial position and/or orientation of either one or both of the tethered pair of base system objects, 401. Position and orientation can be maintained by generating a net force vector equal in magnitude but opposite in direction to the net force vector acting on one or both of a tethered pair of base system objects, 401. This net gravitational and pressure force vector will be constantly varying in direction and magnitude; however, because this net vector will always be very small in magnitude, only very small quantities of ion engine fuel will be needed for a pair of ion engines operating cooperatively—refueling and/or maintenance missions to each base system object can easily be years or even decades apart.

FIG. 5c illustrates elements of a base system object, 401, of the present invention previously detailed with reference to FIG. 5, FIG. 5a, and FIG. 5b, comprising, referring again now to FIG. 5c, an N by N array, 411, of planar reflective surface modules, 421, a rigid positional management frame, 501, above and adjoining an planar outer perimeter frame structure, 431, eight positional management frame struts, 502, meeting at a positional management structure central joint, 503, above the planar outer perimeter frame structure, 431, and a positional management module, 504. Each positional management module, 504, further comprises a plurality of thin, ultralight, planar reflective surface module positioning cables, 520. FIG. 5c illustrates four such cables, each having one end attached to one corner, 441, of the same planar reflective surface module, 421, and each having its opposite end attached to a length adjusting and tensioning control component of the positional management module, 504, that individually manages the length and tension of every planar reflective surface module positioning cable, 520.

FIG. 5c1 is similar to FIG. 5c, as described above, but referring now to FIG. 5c, omits illustrating the positional management frame struts that meet at a positional management structure central joint, 503, referring now to FIG. 5c1, and a positional management module, 504. However, FIG. 5c1 further illustrates an aluminum surface module positioning cable, 520, for each corner of each planar reflective surface modules, 421, of the N by N array, 411.

Each said aluminum surface module positioning cable further comprises tensioning, length-varying and oscillation dampening means, such that a constant tension may be maintained over the length of the cable, and such that, referring now to FIG. 6, when a pair of aluminum surface module positioning cables, not illustrated, attaches to the same corner of the same aluminum surface module, also not illustrated, and both cables are independently managed by their respective adjusting and tensioning control components of the two opposite positional management modules, 504, of a base system object, 401, now referring to FIG. 5-2, the position of an aluminum surface module corner, 441, is acted on by the tension of any attaching extensible tie structure, 442, together with the tension of each of the two attaching aluminum surface module positioning cables, not illustrated, such that, referring now to FIG. 6, the position and stability, including but not limited to instability associated with oscillation, of each corner of each said aluminum surface module, not illustrated, of the said N by N array, not illustrated, can be controlled so precisely that the reflected radiation from each aluminum surface module, not illustrated, can be directed with sufficient precision over a first range of distances of approximately a million miles, such as to make practicing the present invention practical. It may be possible to practice the present invention according to scenarios involving Lagrange Points 4 and 5, over distance ranges of approximately one hundred million miles, however, as noted, that admittedly poses additional practical challenges. It should be noted that even when there is a loss of some of the reflected radiation due to variations in accuracy caused by reflective surface imperfections and/or positional instability, including but not limited to instability arising from oscillations, and additional variation possibly caused by other optical issues that may emerge, the design of sufficiently large base system objects with a sufficiently large value or N in their associated N by N matrix, can mitigate what will likely be, on a practical basis, random variation in the precise directing of a flux of radiation. The key is to first deliver a significant percent of radiation first reflected from near L1 Prime to base system objects typically orbiting Earth at about 25,000 miles or closer; such that once those relatively close base system objects receive the radiation, they can be engineered to reflect it to targets on or near the Earth with sufficient precision. On an as-needed basis, more expensive but more optically precise base system objects can be engineered for use.

It should be noted that for base system objects having large N by N arrays, positioning management of individual aluminum surface modules, as has been described, can be undertaken such that various patterns of radiation distribution can be formed over the area of a target. Such patterns can be managed to irradiate dimensions and shapes of both final optical targets, and intermediate optical targets including but not limited to base system objects orbiting the Earth.

When a single base system object is functioning independently in global cooling mode, it is situated within Space Zone One, and one surface, which may be reflective as described above, or which may comprise an absorbing layer to mitigate the effect of radiation pressure, is positioned such that is approximately perpendicular to the line from the centers of gravity of the Sun and the Earth. The effect is to redirect or absorb and disperse radiation that would have otherwise reached the Earth; thus, the total energy reaching the Earth from the Sun is reduced, and global warming is mitigated.

When and if needed, cooperating ion engines of each base system object can also be used to redeploy, re-orient and re-purpose any base system object within any of the Space Zones One through Four.

A base system object can also be deployed and redeployed in any of Space Zones One through Four, such that it can work cooperatively with one or more other reflective object systems, and in a plurality of other modes.

Base system objects, termed near-Earth base system objects, comprise objects that will also be deployed and managed in geosynchronous orbital paths, geostationary orbital paths, near-geostationary orbital paths and geoproximate orbital paths. As with base system objects deployed near L1 Prime, the engine fuel requirements of such base system objects will be small, so maintenance and servicing schedules can be very infrequent.

Regarding near-geostationary and geoproximate orbital paths, such orbital paths are approximately circular, with a radius that ranges for near-geostationary orbital paths from approximately ten miles greater than to approximately ten miles less than the 26,199 mile radius from the center of the Earth of a circular geosynchronous orbit, and for geoproximate orbital paths, a radius that ranges from approximately two thousand miles greater than to approximately two thousand miles less than the 26,199 mile radius from the center of the Earth of a circular geosynchronous orbit. Near-geostationary orbital paths will typically be in a plane that is at a maximum angle of incidence to the equatorial plane of one degree. Because the orbital radius of near-geostationary orbits is so close to a perfectly geostationary orbital path, an object following that orbital path changes its position with respect to a fixed point on the Earth's surface only very slowly.

When near-Earth base system objects are deployed, they can function cooperatively with base system objects in Space Zones Two and Four that are in second reflector mode. These objects in second reflector mode intercept radiation directed towards them from cooperating tethered and/or untethered base system objects operating in Space Zones One and Three, and operating in first reflector mode, and redirect the radiation either directly towards the Earth, or towards near-Earth base system objects. The control and maneuvering modules of all three of the cooperating base system objects is coordinated such that the radiation can be directed at the desired point on the Earth's surface, whether that point is stationary or moving up to 1,000 miles per hour with reference to the Earth's surface. It should be noted that a plurality of base system objects operating in second reflector mode can direct their radiation towards the same base system object orbiting the Earth, that base system object can be operated such as to both divide and/or slightly disperse the received radiation, such that it reaches multiple points on or near the Earth's surface, at an intensity regulated by the dispersion from the Earth orbiting base system object.

FIG. 6a illustrates the Sun, 100, the Earth, 150, and L1 Prime, 170, in its orbital path, 171. To direct radiation to a point such that the Earth is between it and L1 Prime, referring an enlarged view of the object scheme of FIG. 6a, referring now to FIG. 6a1, this illustration further comprises two base system objects, 401, joined by a tether, 450, and straddling the L1 Prime orbital path, 171. A first base system object, 451, is situated in Space Zone One, is operating in first reflector mode, and further comprises a first reflecting surface, 452, that is situated such that it reflects radiation from the Sun at an angle x, 470, from a first ray of Solar radiation, 181, which, as it becomes a second ray of solar radiation, 182, is reflected from a second reflecting surface, 462, of a second base system object, 461, situated in Space Zone Two, and operating in second reflector mode. This ray becomes, in turn a reflected third ray of solar radiation, 483, which could have been directed to a target on the Earth, or near the Earth's surface. However, for purposes of the FIG. 6a illustration, this third ray of solar radiation, 483, is instead directed, now referring to another enlarged view of the object scheme of FIG. 6a, FIG. 6a1, to a third base system object, 471, where it is again reflected as a fourth ray of solar radiation, 484, to a target on the Earth, or near the Earth's surface. In this way, tethered pairs of base system objects of the present invention near L1 Prime, or two base system objects not tethered to each other, and operating near L1 Prime, can work cooperatively to, in effect, reroute radiation that would have irradiated an area of the Earth's surface to the area of a different target on or near the Earth's surface.

As further illustrated by FIG. 6a, FIG. 6a1 and now referring to FIG. 6a2, a third base system object, 402, orbiting the Earth can also work cooperatively with the other two base system objects such that the same radiation can reach a target on or near the Earth's at what is night time for that target. Note, while the approximate orbit of the third base system object, 402, is suggested to be of diameter similar to a geosynchronous orbit, the orbit illustrated for the third base system object, 402, is not in the plane of a geosynchronous orbit.

It will be understood that base system objects of the present invention that are in any Earth orbit, whether LEO, geosynchronous, geostationary, near geosynchronous, or other, can draw radiation for reflection to a target on or near the Earth's surface either from one or more cooperating base system objects in second reflector mode, or alternatively can reflect radiation arriving directly from the Sun. The disadvantage of using radiation arriving directly from the Sun is that because it would not otherwise have reached the Earth, it contributes to global warming. However, this may be mitigated simply by deploying additional cooling system objects between the Sun and the Earth near L1 Prime, and/or by deploying a higher percentage of tethered base system objects in full global cooling mode. FIG. 6b1 illustrates a base system object, 401, orbiting the Earth with an orbital diameter approximately that of a geosynchronous orbit, and tethered to a cooling system object, 301, that is blocking direct solar radiation, 305. However, the base system object, 401, is receiving incident radiation, 475, that is from a base system object in second reflector mode, not illustrated, which becomes reflected radiation, 476, directed towards the Earth. The point of this scheme is to illustrate the ability of a third base system object to be deployed cooperatively with a cooling system object such as to ensure that only radiation reaching the third base system object from other base system objects in second reflector mode will reach the Earth. In this way, the cooling system object diverts radiation from the Earth that could be thought of as a kind of “radiation pollution.” It will be understood that when third base system objects orbiting the Earth are referred to as working cooperatively with other base system objects, they can either be receiving radiation from other base system objects in second reflector mode, or the can be receiving radiation directly from the Sun; when the radiation received is directly from the Sun, then typically other base system objects and/or cooling system objects will be deployed such as to offset for the additional solar radiation that would otherwise not have reached the Earth.

FIG. 6b illustrates the scheme detailed in FIG. 6b1, referring now to FIG. 6b, a third base system object, 401, receives radiation, 475, from another base system object in second reflector mode, not illustrated, near L1 Prime, 170, and reflects it, 476, towards a target on or near the surface of the Earth, 150.

FIG. 6c illustrates four base system objects, 401, at different points in the same orbital path, 601, around the Earth, 150; the orbital path, 601, is not geosynchronous, but illustrates an approximately geosynchronous orbital diameter. Although not illustrated, it is understood that each of the base system objects, 401, of FIG. 6c, now referring to FIG. 6b1, is tethered to a cooling system object, 301, which blocks solar radiation, 305, from directly reaching the base system object, 401. Referring now to FIG. 6c, each base system object, 401, is receiving both radiation directly from the Sun, 305, which is intercepted by the cooling system object, not illustrated, and radiation, 475, from another base system object in second reflector mode, not illustrated, near L1 Prime, 170, and reflects this radiation, 476, towards a target on or near the surface of the Earth, 150. We can see that because the radiation directly from the Sun, 305, comes always from the direction of the Sun, not illustrated, therefore, as a base system object, 401, orbits the Earth, to maintain that orientation, referring now to FIG. 6b1, the tethered pair of a base system object, 401, and a cooling system object, 301, must revolve once around their common center of gravity, 602, for each orbit they complete around the Earth, not illustrated, irrespective of the direction in which the base system object, 401, may be tilted to direct reflected radiation, 476, towards its target on or near the Earth's surface. Referring now to FIG. 6c, two potential lines of reflected radiation, 603, reaching the same spot on or near the Earth's surface, 604, that is on the line, 160, between the centers of gravity of the Earth and the Sun, illustrate that a series of third base system objects, 401, can direct their reflected radiation such as to continuously radiate all points on the Earth, or near its surface, at any time, day or night. During daylight hours on the Earth, radiation from base system objects in second reflector mode can be targeted directly to a point on or near the Earth's surface, without any need for cooperating third base system objects.

A set of base system objects can be deployed in the same common near-geostationary or geoproximate orbital path, at approximately equal spacing from one another, such that as the reflecting geometry of the orbit of one base system object in the common orbital path become less favorable when used cooperatively with base system objects near L1 Prime, and typically with one or more base system object operating in Space Zone Two or Space Zone Four, to direct radiation at a zone of radius one thousand miles centered on a particular location on the Earth's surface, the cooperating base system object or objects in Space Zone Two or Space Zone Four can redirect their radiation to the next base system object in the said common orbital path, such that the reflective surfaces of the base system objects direct the radiation to the same zone of radius one thousand miles centered on a particular location on the Earth's surface, and reflecting geometry of the next cooperating base system object and the cooperating base system object(s) in Space Zone Two or Space Zone Four becomes more favorable. Note that this process is with reference to a zone, it can be used both for stationary points at a particular point on or near the Earth's surface, or points that at one moment define the said zone of radius one thousand miles and are moving with respect to the Earth's surface at speeds up to a thousand miles an hour, or more. Because both the cooperating base system objects and the stationary or moving target point with reference to the Earth's surface are all in motion, the controlling and maneuvering modules of each cooperating base system object will be continuously managing and adjusting the position of the reflective surfaces to direct the radiation at each moment to the desired location respect to the Earth's surface.

FIG. 6d illustrates the Sun, 100, the Earth, 150, and Lagrange Point L5, 190, in its common orbital path, 151, with the Earth, 150, around the Sun, 100, and the equilateral triangle, 191, situating L5. FIG. 6d1 enlarges detail of FIG. 6d, and, now referring to FIG. 6d1, illustrates a base system object, 401, near Lagrange Point L5, 190, and proceeding in an orbital path, 151, around the Sun, 100. Radiation from the Sun, 305, is reflected by the base system object, 401, and becomes reflected radiation, 306, directed towards, referring now to FIG. 6d2, another base system object, which becomes reflected radiation, 307, directed towards a target on or near the Earth's surface that is near the center of gravity axis, 160, between the Earth and the Sun. Thus, it is possible to use base system objects of the present invention at Lagrange Point L5, or Lagrange Point L4, not illustrated in FIG. 6d, but which now referring to FIG. 1, is symmetrical, working cooperatively with other base system objects orbiting the Earth, to direct solar energy to targets on the Earth or near its surface at night. However, referring now to FIG. 6d, because the path of radiation, 306, reflected from near Lagrange Point L5 to the Earth is, as noted close to 100 million miles, rather than the approximately one million miles from L1 Prime to near the Earth, the challenge of practicing the present invention with involvement of Lagrange Points other than L1 Prime is significant. On the one hand, it is possible, but on the other hand, the ability to use third base system objects orbiting the Earth to reach targets at night appears to be both fully adequate, and easier to implement.

### Base System Object Deployment Modes

First and second deployment modes comprise base system objects operating in a global warming first reflector mode, and a global warming second reflector mode, respectively. Referring now to FIG. 3a, when a base system object, not illustrated, is operating in a first deployment mode, it is operating in global warming first reflector mode, the object is situated in Space Zone Two, 251, where it intercepts radiation from the Sun that would otherwise pass near the Earth, but would not reach the Earth's surface. This radiation is directed towards a cooperating second base system object, not illustrated, that is operating in a second deployment, and in global warming second reflector mode and is in Space Zone Four, 281, where it also intercepts radiation from the Sun that would otherwise pass near the Earth, but would not reach the Earth's surface. This radiation is redirected by the base system object operating in global warming second reflector mode towards the Earth's surface. These two cooperating base system objects thus increase the net radiation reaching the Earth, and thus increase global warming and counter-act global cooling. As long as global warming, and not global cooling, continues to be a problem, these second and third deployment modes will not be used; however, if Earth ever enters a period of global cooling, base system objects can easily and economically be redeployed to function cooperatively in first and second deployment modes, to counteract global cooling. It should be noted that all other deployment modes, which are premised on the plan to use tethered pairs of base system objects, are also premised on the assumption that our problem is global warming, not global cooling; therefore, although the pairs are to be deployed in Space Zones One and Three, their deployments can, as noted, be changed to Space Zones Two and Four, respectively, in which case their overall effect would be to mitigate global cooling, and not global warming.

Third and fourth deployment modes comprise base system objects operating in a global cooling and light/warmth redistribution first reflector mode, and a global cooling and light/warmth redistribution second reflector mode, respectively. When a base system object is operating in global cooling and light/warmth redistribution first reflector mode, the object is situated in Space Zone One, where it intercepts radiation from the Sun that would otherwise reach the Earth's surface. This radiation is directed towards a cooperating second base system object that is in Space Zone Three, where it also intercepts radiation from the Sun that would otherwise reach the Earth's surface, and that is operating in global cooling and light/warmth redistribution second reflector mode.

Beyond this net effect of mitigating global warming, there is a significant increase in both light and warmth at the second location on the Earth's surface. Note that deployment modes for both weather and extreme weather situations are covered later and separately; beyond that category, multiple potential uses emerge from deployment modes one and two. For metropolitan areas in colder climates, the ability to provide a localized increase in warmth could be used to mitigate the cold of winters, and could potentially also be used to manage or in some scenarios eliminate snow and/or ice during winter months. The ability to provide light could be used to artificially extend daylight hours during winter months, when days are otherwise significantly shorter—this can ensure people are receiving sufficient vitamin D from sunlight, and could also have an important impact on the psychological well-being of individuals. The ability to manage the focal point of light from an N by N array of reflective aluminum surface modules of a base system object operating in global cooling and light/warmth redistribution second reflector mode can also facilitate a kind of dimmer feature, for major metropolitan areas, allowing low intensity night lighting with no need for an electrical grid or electric street lights.

Fifth and sixth deployment modes comprise base system objects operating in a global energizing first reflector mode and a global energizing second reflector mode, respectively. When a base system object is operating in global energizing first reflector mode, the object is situated in Space Zone One, where it intercepts radiation from the Sun that would otherwise reach the Earth's surface. This radiation is directed towards a cooperating second base system object that is in Space Zone Three, having a Sun-oriented side that also intercepts and reflects away from the Earth radiation from the Sun that would otherwise reach the Earth's surface, and that is operating in global energizing second reflector mode. Depending on what point on the Earth's surface the energizing radiation is to be directed, the second base system object sometimes directs the energizing radiation directly to that point, while for other situations and times the base system object operating in global energizing second reflector mode directs the energizing radiation to a third, Earth orbiting base system object; in either case the two or three base system objects position their reflective surfaces cooperatively to direct the energizing radiation to the desired point on the Earth's surface, which may be stationary, or in motion at any speed up to 1,000 miles per hour, and may be accelerating or decelerating at a moderate and relatively constant rate and direction.

As already described, the target center of the energizing radiation may be centered on a stationary or moving point on the surface of the Earth, or alternatively may be at a height of up to as much as approximately 20 miles above the said target center point. The target surface will typically be an array of solar panels with electrical wiring beneath, engineered to draw maximum electrical power in the form of DC current generated by the incoming solar radiation.

Due to the locations of cooperating base system objects—one in Space Zone One and the other in Space Zone Three, the net effect is to redirect half of the total radiation that was in route to a first location on the Earth's surface to a second location on the Earth's surface, while the reflective surface of the base system object in Space Zone Three prevents the other half of the radiation from reaching the Earth. Thus, there is approximately a 50% decrease in the total radiation reaching the Earth. Beyond this net Global Cooling effect, because most of the radiant energy that reaches solar panels is not converted to DC current, and is reflected back into space before passing through a significant percentage of the atmosphere compared to radiation that reaches the Earth's surface, and considering that about 70% of solar radiation reaching the Earth is absorbed, it will be necessary to determine through further analysis, and/or empirically, the total net effect of deployment modes five and six on Global Warming or Global Cooling.

The primary purpose of deploying base system objects operating in a global energizing first reflector mode and a global energizing second reflector mode is to convert solar energy into usable DC electricity. This electricity can then be converted to AC when and as needed; the electricity can be used for various purposes. As a first example, an array of solar panels can be installed on the surface of the Earth—desert locations with only very infrequent obstructing clouds are highly desirable locations—and can then be used to generate electricity continuously, 24 hours a day, seven days a week. It should be noted that in some cases it may be practical to irradiate these Earth-mounted solar panels at an intensity greater than they receive from natural sunlight—by directing radiation towards them during daylight hours, and by increasing the total intensity of radiation reaching them at night—this can increase the total production of electricity from the solar panels. Consideration must be given to ensuring that the total intensity is not such as to harm birds and other life that fly or otherwise pass over the solar panels. It may be practical to build massive walls, comprising a low surface wall for all non-flying life, and a net structure above it, around large designated “farm” areas of solar panels, which could be partially or completely supported by lighter than air technology, and which could prevent birds from reaching irradiated areas. Effects on atmospheric temperature from such massive concentrations of solar radiation must also be studied. As a second example, the present invention can be used cooperatively with giant platforms supported permanently in the upper atmosphere by means of lighter-than-air technology and structures, said platforms further comprising arrays of solar panels that power an electromagnetic mass driver that can be used to continuously or almost continuously launch payloads into orbit. While probably unsuitable for putting people into orbit due to the high acceleration and high g-force produced, such mass drivers can be used to economically accelerate materials and components of all kinds into orbit around the Earth, including robotic equipment, either directly, or in combination with chemical rockets that provide the needed final acceleration to reach orbital velocity. Because the weight of chemical rockets is either entirely eliminated or greatly reduced, putting payloads of materials, robotics, and pre-assembled modules needed to produce, place in orbit, and subsequently deploy cooling system objects, base system objects into orbit, and other needed elements, in quantities sufficient to have an adequate impact in reducing and/or managing Global Warming, is a practical application of the present invention. Both cooling system objects and base system objects of the present invention can be manufactured in space, deployed as need in mass quantities, and serviced as needed, using only robotic technology. As a third example, aircraft, either heavier-than-air, or lighter-than-air, or hybrids, can have upper surfaces comprising solar panels, and can be powered continuously by means of two and sometimes three cooperating base system objects coordinated such as to direct a constant supply of radiant power to the aircraft, regardless of where it is over the surface of the Earth, and without reference to day or night.

Seventh and eighth deployment modes comprise base system objects operating in a global extreme weather management first reflector mode and a global extreme weather management second reflector mode. The basic idea behind these two extreme weather management modes is to have the ability to direct massive quantities of solar energy intermittently and for relatively short periods of time, such as to cause controlled atmospheric pressure changes and consequent changes in air flow in a region, or along a line. A first application example is the potential to disrupt and dissipate hurricanes that are starting to form—in effect to mitigate one of the major environmental problems associated with Global Warming. Best practices models for how to do this will need to be developed. A second and more problematic example is, by means of directing energy, to manage local regions of air pressure, to disrupt or split up major blizzards, such that they pass by large metropolitan areas, preventing accumulations of snow that can be both hazardous and disruptive to transportation systems. Further research is needed—the point being made here is that the present invention can supply massive quantities of energy, and in a sufficiently controllable way, such that these applications may become not just practical but imperative, due to ethical, environmental, and economic considerations.

It should be noted that because deployment modes seven and eight will typically be used on a temporary and intermittent basis, and given that our current challenge is to reduce Global Warming, a set of base system objects can, in effect, be “toggled” between Global Cooling Mode and global extreme weather management first reflector mode, simply by keeping them focused near to but not on a corresponding base system object that is available for functioning in global extreme weather management second reflector mode, and such functioning can also be intermittent. During such temporary redeployments, the two cooperating base system objects function as described above. Otherwise, the effect is that both of the cooperating base system objects operate on a de facto basis in Global Cooling Mode, although one of them is in Space Zone Three rather than Space Zone One.

Ninth and tenth deployment modes comprise base system objects operating in a global water desalinization and water splitting first reflector mode and a global water desalinization and water splitting second reflector mode. Water desalinization technology is becoming more practical, such that the breakeven when compared to transportation and/or lifting costs of fresh water is about 2,000 meters of height or 1,600 kilometers of transporting distance. Because steam moves according to pressure, and the present invention can provide heat for steam generation and maintenance in abundance, it may be possible to develop massive steam pipelines for transport, condensing steam to fresh water as it arrives. Advances in electrolysis and photoelectrochemical processes also appear to be making large-scale production of hydrogen fuel from water practical. Because water splitting is more efficient when done with electricity than when done with solar radiation, production of hydrogen fuel in massive quantities may be done using Earth mounted solar panels powered by radiation from the present invention. Alternatively, high altitude solar panels, supported by lighter than air technology, tethered to Earth, and connected to Earth by high voltage conducting cables, may also be practical.

Eleventh and twelfth deployment modes comprise base system objects operating in a global weather management and optimization first reflector mode and a global weather management and optimization second reflector mode. The basic idea behind weather management and optimization is to direct quantities of solar energy intermittently and for relatively short periods of time, such as to cause controlled atmospheric pressure changes and consequent changes in air flow and/or precipitation in a region, or along a line. Examples are, by means of directing energy, to manage local regions of air pressure such that heat waves, cold snaps, and/or drought conditions, including supplying needed quantities of water for irrigation, can be mitigated and/or managed. Much further research is need for this example—the point being made here is that the present invention can supply massive quantities of energy, and in a sufficiently controllable way, such that these applications may also become not just practical but desirable, due to ethical, environmental, economic and social justice considerations.

Best practices models for how to carry out these deployments, if it emerges they are practical and can be sufficiently beneficial, will need to be developed—the point being made here is that the present invention can supply massive quantities of energy, and in a sufficiently controllable way. There is much potential for managing winter weather for major but cold metropolitan areas—subject of course to the requirements of political consensus and study to ensure unacceptable new environmental problems won't result.

It should be noted that because deployment modes eleven and twelve will typically be used on a temporary and intermittent basis, and given that our current challenge is to reduce Global Warming, a set of base system objects can, in effect, be “toggled” between Global Cooling Mode and global weather management and optimization first reflector mode, simply by keeping them focused near to but not on a corresponding base system object that is available for functioning in global weather management and optimization second reflector mode, and such functioning can also be intermittent. During such temporary redeployments, the two cooperating base system objects function as described above. Otherwise, the effect is that both of the cooperating base system objects operate on a de facto basis in Global Cooling Mode, although one of them is in Space Zone Three rather than Space Zone One.

As a general comment, since for deployment modes three through twelve, base system objects in first reflector mode are in Space Zone One and base system objects in second reflector mode are in Space Zone Three, the net effect is to redirect half of the total radiation that was in route to a first location on the Earth's surface to a second location on the Earth's surface, while the Sun-oriented side of the reflective surface of the base system object in Space Zone Three directs the other half of the radiation reaching it away from the Earth. Thus, there is approximately a 50% decrease in the total radiation reaching the Earth, providing net Global Cooling and mitigating against Global Warming.

Additional deployment modes are possible, contemplated, and are explicitly asserted to be part of the invention, however those presented and detailed in this specification are sufficient to give a sense of teaching the invention, and of the scope, ways and flexibility to be accorded to the practice of the invention. More particularly, these deployment modes demonstrate that beyond the benefit of a system for reducing and/or reversing global warming, and for, over time, implementing a system that comprises a global thermostat, providing means to manage the temperature of the entire planet, the present invention is conceived such that other benefits from practicing the present invention are so great that it can and should be practiced whether global warming, or global cooling (another ice age is possible), are, or are not, a real problem for our environment and for humanity, either presently or potentially at some future time.

It will be understood that the present invention comprises both other preferred embodiments and applications that, while not detailed in this specification, are within the teaching, spirit and scope of the invention, as can be reasonably inferred from the teachings, the level of detail, the referenced illustrations, and the explanations offered in this specification. More specifically, it will be understood that this specification's focus on particular embodiments, and particular purposes, cannot limit the described invention, because this specification expressly and explicitly contemplates further embodiments and purposes.

I claim:

1. A pair of cooling system objects, joined by a tether at a central strut joint, each said cooling system object further comprising:
a. a continuous planar surface of radiation absorbing material, and
b. the said continuous planar surface mounted within and attaching to a continuous, planar, outer perimeter frame structure, and
c. three or more struts, each attaching to the said continuous, planar, outer perimeter frame structure, and
d. the said struts meeting at a central strut joint, and
e. a control and maneuvering module, attaching to each said continuous, planar, outer perimeter frame structure.

2. A pair of base system objects, joined by a tether at a positional management structure central joint, each said base system object further comprising
a. a planar outer perimeter frame structure, of aluminum struts or other rigid material, further comprising the continuous, joined bases of three or more outer isosceles triangles, and defining a reflective surface plane, and,
b. on each side of the said planar outer perimeter frame structure, a pyramid-like rigid positional management frame, above and adjoining one side of the said planar outer perimeter frame structure, and further comprising three or more positional management frame struts; each of these struts attaching at one end to a positional management structure central joint, above one side of the said reflective surface plane, and each of these struts attaching at the other end to either a joint formed by two adjacent outer isosceles triangle bases, or to a said outer isosceles triangle apex, and
c. within each of the said base system object planar outer perimeter frame structures an N by M array of planar reflective surface modules, where N and M are equal or unequal integers greater than 1, and
d. each of the said planar reflective surface modules further comprising
i. a continuous, enclosing planar surface structure, further comprising three or more bowed, rigid side struts, each of which may be aluminum or some other light, rigid material, and
ii. within each said continuous, enclosing planar surface structure, a planar, polished, reflecting surface, continuously attaching to the said continuous, enclosing planar surface structure, and
iii. each corner of each said continuous, enclosing planar surface structure attaching to one or a plurality of extensible tie structures connecting to either adjacent corners of other said continuous, enclosing planar surface structures, or to the inner perimeter of the said rigid positional management frame, and
e. attaching to a said positional management structure central joint on each outer side of each of the said base system objects, a positional management module, further comprising
i. a positional management module fuel tank, and
ii. a positional management module solar panel structure, and
iii. a positional management module first engine, and
iv. a first engine positioning and directional structure.

3. The pair of base system objects of claim 2, further comprising for either one or both base system objects, a plurality of pairs of planar reflecting surface module positioning cables, one of each said pair of positioning cables attaching at one end to one of the said positional management modules attaching in turn to one side of a base system object, and the other end to a corner of a continuous planar enclosing surface structure, and one end the second of each said pair of cables attaching on the opposite side of the base system object to the same corner of the same continuous planar enclosing surface structure, and the other end of the second of each said pair of cables attaching to the positional management module on the opposite side of the base system object.

4. The pair of base system objects of claim 2, further comprising, for one or more of the positional management modules, an attaching second engine positional and directional structure, attaching in turn to a positional management module second engine.

5. A base system object, further comprising
a. a planar outer perimeter frame structure, of aluminum struts or other rigid material, further comprising the joined bases of three or more outer isosceles triangles, and defining a reflective surface plane, and,
b. on each side of the said planar outer perimeter frame structure, a pyramid-like rigid positional management frame, above and adjoining one side of the said planar outer perimeter frame structure, and further comprising a plurality of positional management frame struts; each of these struts attaching at one end to a positional management structure central joint, above one side of the said reflective surface plane, and each of these struts attaching at the other end to either a joint formed by two adjacent of the outer isosceles triangle bases, or to a said outer isosceles triangle apex, and
c. within the said base system object planar outer perimeter frame structure, an N by M array of planar reflective aluminum surface modules, where N and M are equal, and N is an integer greater than 1, and
d. each of the said planar reflective surface modules further comprising
i. a continuous, enclosing planar surface structure, further comprising three or more bowed, rigid side struts, each of which may be aluminum or some other light, rigid material, and
ii. within each said enclosing planar surface structure, a planar, polished, reflecting aluminum surface, continuously attaching to the said planar surface structure, and
iii. each corner of each said planar surface structure attaching to one or a plurality of extensible tie structures connecting to either an adjacent corner of another said planar surface structures, or to the inner perimeter of the said rigid positional management frame, and
e. attaching to the said positional management structure central joint on each side of the said base system object, a positional management module, further comprising
i. a positional management module fuel tank, and
ii. a positional management module solar panel structure, and
iii. a positional management module first engine, and
iv. a first engine positioning and directional structure.

6. The base system object of claim 5, further comprising a plurality of pairs of planar reflecting surface module positioning cables, one of each said pair of positioning cables attaching at one end to one of the said positional management modules attaching in turn to one side of the base system object, and the other end to a corner of a continuous planar enclosing surface structure, and one end the second of each said pair of cables attaching on the opposite side of the base system object to the same corner of the same continuous planar enclosing surface structure, and the said other end of the second of each said pair of cables attaching to the positional management module on the opposite side of the base system object.

7. The base system objects of claim 5, further comprising, for one or both of the positional management modules, an attaching second engine positional and directional structure, attaching in turn to a positional management module second engine.

8. The base system object of claim 5, tethered to a cooling system object, the said cooling system object further comprising:
a. a continuous planar surface of radiation absorbing material, and
b. the said continuous planar surface mounted within and attaching to a continuous, planar, outer perimeter frame structure, and
c. three or more struts, each attaching to the said continuous, planar, outer perimeter frame structure, and
d. the said struts meeting at a central strut joint, and
e. a control and maneuvering module, attaching to the said continuous, planar, outer perimeter frame structure.
